(19) United States
(12) Patent Application Publication
(10) Pub. No.: US 2010/0244438 A1
(43) Pub. Date: Sep. 30, 2010

(54) BARBED FITTING FOR HOSE CONNECTION

(76) Inventor: James E. Johanson, Old Chatham, NY (US)

Correspondence Address: FLASTER/GREENBERG P.C.;Four Penn Center, 1600 John F. Kennedy Boulevard, 2nd Floor, PHILADELPHIA, PA, 19103, US

(21) Appl. No.: 12/411,041

(22) Filed: Mar. 25, 2009

(51) Int. Cl. F16L 33/24

(52) U.S. Cl. 285/148.21

(57) ABSTRACT

A fitting is provided for connecting and disconnecting a system or the like to a hose. The fitting includes a hollow. A barb is located proximate a first end. The barb includes a frusto-conical profile and a helical trailing edge. A rib connects an offset portion of the helical edge forming a sharp axial transition. The axial rib expands the diameter of the hose while the fitting is twisted to facilitate extraction.

### FIELD OF THE INVENTION

The present invention relates to a fitting device for hose connections.

### BACKGROUND OF THE INVENTION

Generally, it is known to connect a hose or tubing to a system or another hose using a barbed fitting. Barbed fittings may include one or more frusto-conical shaped barbs on the insertion end of a hollow tubular structure. These barbs enter into the hose with the lesser diameter end of the barb entering first. The insertion end of the barb is typically slightly smaller than the inside diameter of the hose. The larger end of the barb typically has a greater outside diameter than the inside diameter of the hose, so that the hose is stretched when the fitting is inserted and forms a seal.

U.S. Pat. No. 5,076,615 and U.S. Pat. No. 5,165,733 to Sampson, each entitled, “Apparatus for Connecting an Elastic Hose to a System with an Anti-Hose Rotation Shaped Hollow Body” show various embodiments of a fitting for connecting to a hose. The fittings generally include a frusto-conical barb formed around the insertion end of a hollow fitting. The barb includes a tapered insertion end and enlarged trailing end. In some of the embodiments shown, the trailing end of the barb includes an undulating or angled edge. In other embodiments shown, axially-extending ribs are provided on the barb or extend from the rear or trailing end of the barb.

Another example of a fitting is shown in US 2007/0278789 to Thacker et al. entitled “Hose Coupling Endform For Fluid Transfer Assemblies.” Thacker shows a connector having a sealing member with a frusto-conical barb adjacent a circular portion. The barb has a second end defining an ellipsoidal perimeter, which is asserted to reduce the force required to push the connector into the hose and to provide greater pull-off resistance.

Because of the typical frusto-conical shape of the barb, the force required to remove a fitting from a hose is typically higher than the force required to insert the fitting into the hose. Pulling the fitting for removal causes the hose to stretch, decreasing its diameter and tightening the grip of the hose on the fitting.

When liquid or other fluid material pressurizes the hose, the diameter of the hose or tube expands. Clamps or other attachment devices are sometimes applied on the outside of the tubing at the position of the fitting to prevent the fluid forcing its way around the barb, or through a path defined on the surface of the fitting, and out of the hose when the hose expands.

### SUMMARY OF THE INVENTION

The present invention relates to a fitting for connecting or disconnecting a system or the like to a hose. The fitting includes a hollow body having a longitudinal axis extending lengthwise and a first or insertion end. A barb is provided on the insertion end of the fitting. The barb includes a helical trailing edge and an axial rib connecting the helical edge. The barb may have a smooth frusto-conical surface or define a helical thread having a frusto-conical profile. The rib may connect the rear helical edge of the barb or may extend across the thread that forms the barb.

The second end of the fitting may comprise any number of structures. A stem may be located proximate the second end for connecting the body to the system. The second end may also include a second insertion end for connecting to another hose. Other connecting means may also be provided on the end of the fitting, opposite of the barb.

### BRIEF DESCRIPTION OF THE DRAWINGS

For the purpose of illustrating the invention, the drawings show forms that are presently preferred. However, it should be understood that the invention is not limited to the precise arrangement and instrumentality shown in the drawing.

FIG. 1 is a perspective view of a first exemplary embodiment of a fitting apparatus for connecting a system or the like to a hose.

FIG. 2 is a cross sectional view of the fitting of FIG. 1.

FIG. 3 is a side elevation view of the fitting embodiment of FIGS. 1 and 2 shown with a hose prior to connection with the hose.

FIG. 4 is a perspective view of a further fitting embodiment.

FIG. 5 is a side elevation view of the fitting shown in FIG. 4.

### DETAILED DESCRIPTION

Referring now to the drawings, wherein like numerals identify like elements, there is shown various representations of a fitting for connecting a system (or the like) to a hose and a method for disconnecting the hose from the fitting.

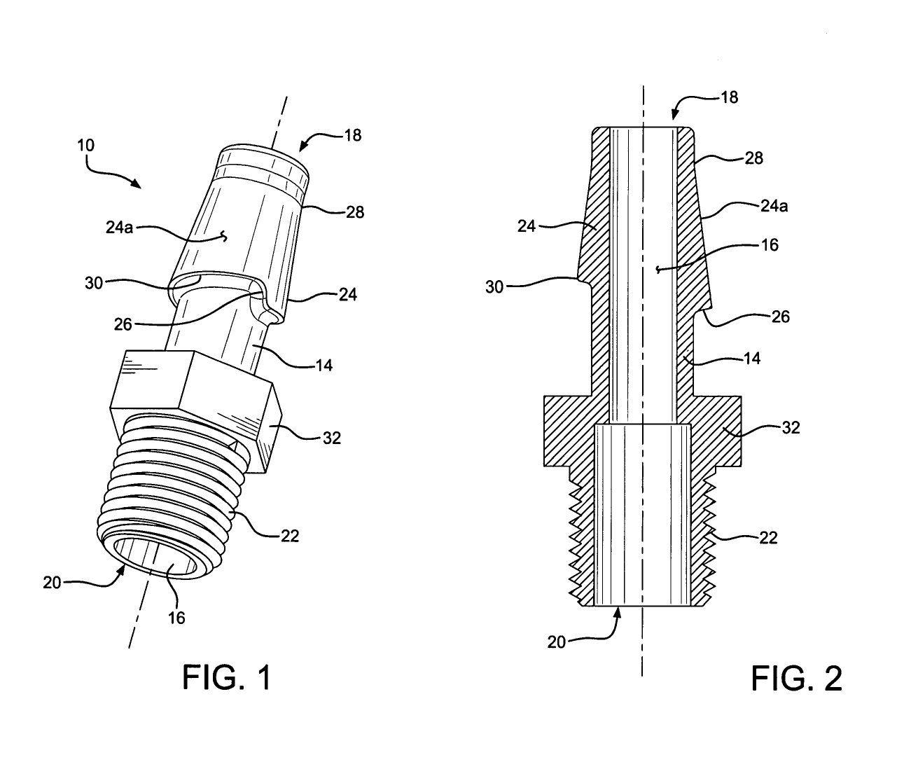

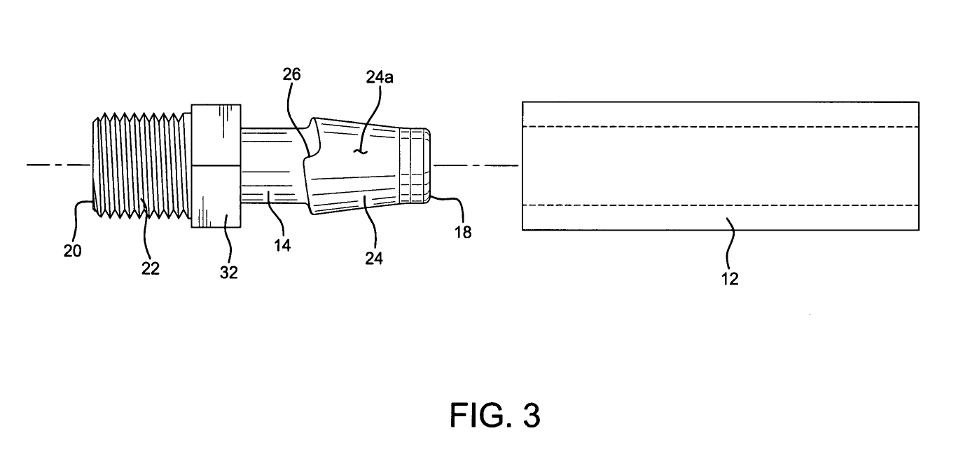

In FIGS. 1-3, there is illustrated a fitting 10 for connecting a system, hose or the like (not shown) to a hose or tubing 12 (FIG. 3). The fitting 10 includes a hollow body 14, preferably having a cylindrical inner surface 16 formed around a longitudinal axis. The longitudinal axis extends lengthwise between a first or insertion end 18 and an opposite second end 20. As illustrated, a stem 22 is located proximate the second end 20 for connecting the body 14 to the system (not shown). The stem 22 includes a connecting means, which as shown is in the form of a series of male threads for mounting in a female threaded opening or connector within a system. Other connecting means may be provided as desired, including a barbed surface of different or similar form as that on the insertion end 18. In addition, the fitting 10 may include an angled passage, a valve or other internal structures.

A barb 24 is located proximate the first end 18 for connecting the body 14 to the hose 12. The enlarged or trailing end 30 of the barb 24 defines a helical edge with an axial rib 26 connecting the offset of the helix. The offset of the trailing end 30 is shown by the cross section of FIG. 2 and in the profile view of FIG. 3. As will be discussed in more detail below, the axial connector or rib 26 is configured to allow the fitting 10 to efficiently separate from the hose 12.

A collar 32 is located between the trailing end 30 of barb 24 and the stem 22. As shown, the collar 32 has a polygonal shape that serves as an engagement surface for rotational driving of the stem threads 22 into a mount, such as by a wrench or other drive mechanism.

The barb 24 includes a substantially smooth, frusto-conical shaped outer surface 24a, initiating at a base 28 and ending at the trailing end 30. The helical edge of the trailing end 30 and the connecting axial rib 26 form the end of the barb 24. The rib connector 26 has an outer surface that is substantially flush with the adjacent portions of the barb 24. The rib 26 in combination with the helix of the trailing end 30 defines an undulating edge having a steep axial transition or step. As shown, a single axial step is formed by the rib 26 on the trailing end 30 of the barb 24. Additional axial transitions or steps may be formed on the tailing edge, at various angular positions around the circumference of the barb 24.

The axial rib 26 allows the barb 24 to expand the inner diameter of the hose 12 when the fitting 10 is twisted relative to the hose 12. This expansion of the hose 12 is intended to reduce the force required for removal of the fitting 10 when the rib 26 is rotated in the direction of the smooth surface 24a of the barb 24. Thus, there is a reduction in the force required for removal of the fitting 10 when, as shown in FIG. 3, the rib 26 is rotated downward (which is clockwise when viewed down the axis from the end 120 opposite of the hose 12). This rotation is opposite of the helix of the trailing end 30 of the barb 24. In addition, the axial nature of the rib 26 expands the hose 12 as an axial withdrawing force is applied to the fitting 10.

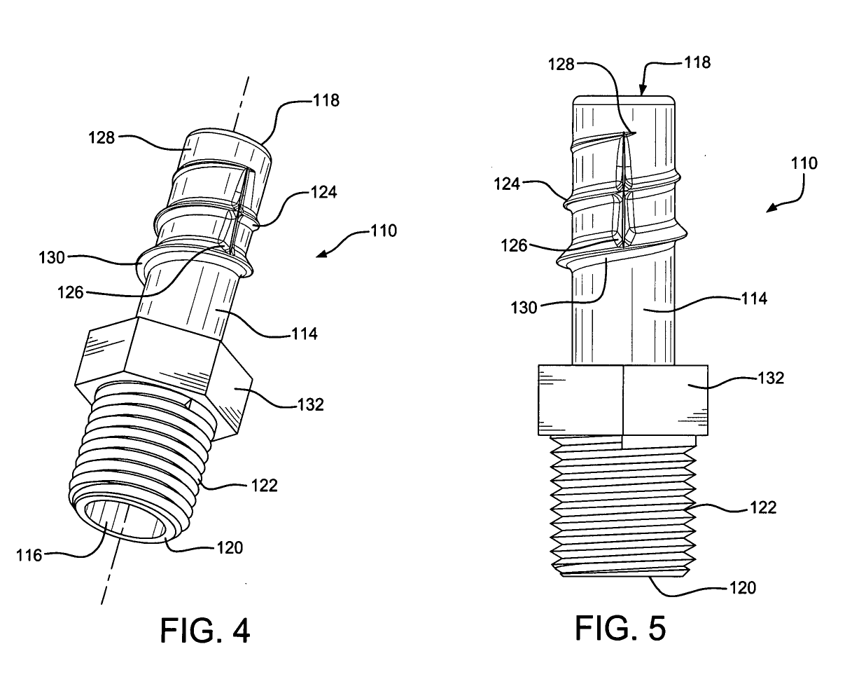

A second embodiment of a fitting 110 is shown in FIGS. 4 and 5. The fitting 110 includes a barb in the form of a helical thread 124, which is wound around the fitting body 114. An axially extending rib 126 is provided across the thread 124 and extends along the root of the thread. The rib 126 includes an outer surface preferably having a similar height as the major diameter of the helical thread 124. As shown in profile in FIG. 5, the major diameter of the helical thread 124 increases moving in a direction away from the insertion end 118 of the fitting 110. The radially outer surfaces of the thread 124 form a frusto-conical profile, enlarging in the direction of the trailing end 130 of the helix. The frusto-conical profile of the thread 124 (as well as the threaded surface) serves to enlarge the inner diameter of the hose (12) as the fitting 110 is further inserted therein.

As contemplated by the first fitting embodiment, the axial rib 126 of fitting 110 facilitates extraction of the fitting 110 by limiting restriction of the hose around the threaded surface. As a result, the rib 126 is contemplated to reduce the force required to remove the fitting 110 from a hose, as the fitting is twisted with respect to the hose.

As shown, the fitting 110 includes a first cylindrical portion at the insert end 118, located forward of the starting position 128 of the thread 126. A second cylindrical portion 114 is provided between the trailing end 130 of the thread 124 and a collar 132. A threaded stem 122 is shown on the opposite end 120 of the fitting body 114, similar in structure to the stem 22 provided in FIGS. 1-3. Other structures may be similarly provided at the opposing end 120 of the fitting 110.

The fitting 110 of FIGS. 4-5 includes a single thread 124 that wraps around the body 114. The axial rib 126 blends with the thread 124 at multiple locations, including the starting position 128 of the thread and at the trailing end 130. In the figures, one rib 126 is shown on one side surface of the fitting 110. A second rib may be located on the opposite side surface. Multiple spaced ribs may also be provided at various angular positions. In addition, the rib may be separated into offset portions that extend between adjacent thread portions. A second thread may also be provided, preferably parallel to and spaced from the first thread. In each of these variations, the rib extends across the root of the thread, thus forming an impediment to fluid under pressure forcing its way around the helical channel formed by the thread. The top edge of the thread and the rib preferably forms a sharp edge, with a pointed or rounded profile. However, different thread and rib profiles are also contemplated.

The ribs have been described herein as being axially positioned. It is contemplated that the ribs may form an acute angle with respect to the longitudinal axis of the fitting end on which the barb is positioned. Thus, a reasonable angular range is encompassed by the present invention without departing from the intended purpose. It is the combination of the helical trailing end of the barb and the connection of the axial offset of the helical edge by the rib that creates the desired advantages.

Although the invention has been described and illustrated with respect to exemplary embodiments thereof, it should be understood by those skilled in the art from the foregoing, that various other changes, omissions and additions may be made therein and thereto, without parting from the spirit and scope of the present invention.

What is claimed is:

1. A fitting apparatus comprising:
a hollow body having a longitudinal axis extending lengthwise along at least an insertion end of the body, and
a barb located proximate the insertion end of the body, the barb having a frusto-conical outer profile, with a narrow end adjacent the insertion end of the body and an enlarged trailing end, the trailing end forming a helical edge, and
at least one rib connecting at least one offset portion of the helical surface at the trailing end of the barb.

2. The fitting of claim 1, wherein the barb comprises a continuous surface extending between the narrow end and the trailing end.

3. The fitting of claim 1, wherein the rib is aligned substantially along the longitudinal axis of the body.

4. The fitting of claim 1, wherein the outer surface of the rib is substantially flush with the adjacent portions of the trailing end of the barb.

5. The fitting of claim 1, wherein the barb comprises a helical thread having a frusto-conical outer profile.

6. The fitting of claim 5, wherein the rib extends across the helical thread at more than one position.

7. The fitting of claim 6, wherein the rib has an outer surface substantially flush with the helical thread at the crossing positions.

8. The fitting of claim 5, wherein the top surface of the rib has the same frusto-conical profile as the helical thread.

9. The fitting of claim 5, wherein the rib extends from the narrow end of the barb to the trailing end.

10. The fitting of claim 9, wherein the rib is aligned substantially along the longitudinal axis of the body.

11. The fitting of claim 1, further comprising a collar located between the barb and the stem.

12. The fitting of claim 11, wherein the collar comprises a substantially polygonal-shaped axial surface.

13. The fitting of claim 11, further comprising a second cylindrical portion located between the barb and the collar.

14. The fitting of claim 1, further comprising a first cylindrical portion between the first end and the barb.

15. The fitting of claim 1, wherein the stem includes a plurality of screw threads.
